(19) United States
(12) Patent Application Publication
(10) Pub. No.: US 2007/0008573 A1
(43) Pub. Date: Jan. 11, 2007

(54) Image forming apparatus and function adding method of image forming apparatus

(75) Inventor: Hirokazu Yamada, Kobe-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/294,406

(22) Filed: Dec. 6, 2005

(30) Foreign Application Priority Data
Jul. 11, 2005 (JP) 2005-201227

(51) Int. Cl. G06F 3/12

(52) U.S. Cl. 358/1.15; 358/448

(57) ABSTRACT

An image forming apparatus is an image forming apparatus to which a function can be added by downloading and installing software for adding the function. The image forming apparatus includes: an information acquiring unit which acquires function information regarding the function which can be added to the image forming apparatus; an operation panel which displays a key in a selectable state, the key being to be displayed when the function is added; and a function managing unit which downloads and installs the software for adding the function corresponding to the key to add the function when the key is selected.

This application is based on Japanese Patent Application No. 2005-201227 filed in Japan on Jul. 11, 2005, the contents of which are hereby incorporated by reference.

### BACKGROUND OF THE INVENTION

1. Field of the Invention

The present invention relates to an image forming apparatus to which a function can be added by downloading and installing software for adding the function, and a function adding method of the image forming apparatus.

2. Description of the Related Art

Although the image forming apparatus mounts various kinds of functions, a new function can be added by downloading and installing software for adding a function recently.

Conventionally, as shown in Japanese Patent Laid-open Publication No. 2004-127281, Japanese Patent Laid-open Publication No. 2002-196933 and Japanese Patent Laid-open Publication No. 2003-241928, a function which can be added to the image forming apparatus is displayed on an operation panel and a function that a user needs is selected and software for adding the function is downloaded and installed. In addition, there is a technique in which software of a mounted function is uninstalled when the user selects it as unnecessary software.

Conventionally, a technique in which a list of functions which can be added to the image forming apparatus is displayed on a screen and when a user selects a necessary function, software corresponding to the selected function is downloaded and installed to execute the selected function has been known. However, in this case, a user has to perform the following two steps such as, firstly, displaying a screen for adding the function and selecting the function to be added and downloading and installing the software to add the function, and secondly, displaying a screen for selecting job contents and selecting the function, other than an usual operation, so that operability is no good.

### SUMMARY OF THE INVENTION

It is an object of the present invention to provide an image forming apparatus in which operability is improved when a new function is added.

An image forming apparatus according to the present invention is an image forming apparatus to which a function can be added by downloading and installing software for adding the function. The image forming apparatus includes: an additional function information acquiring unit which acquires function information regarding the function which can be added to the image forming apparatus; an operation panel which displays a key in a selectable state, wherein the key is displayed when the function is added; and a function managing unit which downloads and installs the software for adding the function corresponding to the key to add the function when the key is selected.

In addition, after the software is downloaded and installed, the function may be executed based on an executing instruction of the added function.

In addition, it may further include a function comparing unit which compares mount information regarding a function mounted on the image forming apparatus and the function which can be added with the function information.

In this case, the function managing unit may acquire a key information regarding the key corresponding to the function which can be added when the function which can be added exists in the function information but it does not exist in the mount information, and

the operation panel displays the key in a selectable state based on the key information.

Furthermore, the function which can be added may have an attribute regarding function addition. In addition, the attribute regarding the function addition may be a kind or a level of importance of the function.

Thus, the function managing unit can perform the following operation a) or b) depending on the attribute of the function,

a) adding the function by downloading and installing the software for adding the function corresponding to the function, and acquiring key information of a key displayed when the function is added, or

b) acquiring a key information of a key displayed when the function is added.

Still furthermore, the function managing unit may determine whether it uninstalls software corresponding to the function and deletes the function or not, depending on whether auto-installation is performed or not.

In addition, the function can be deleted when an deletion requirement is met, and the deletion requirement may be a case where a period in which the function is not used exceeds a predetermined period, a case where a memory of the image forming apparatus runs out, or a case where usage of the function is completed.

In addition, the software can be downloaded from at least one of a server, a terminal device or another image forming apparatus connected to the image forming apparatus through a network.

It is preferable that the key is displayed in the same position and the same design as the case where the software for adding the function is installed and the function is added.

A function adding method of an image forming apparatus according to the present invention is a function adding method of an image forming apparatus to which a function is added by downloading and installing software for adding the function. The method includes: acquiring function information regarding a function which can be added to the image forming apparatus; displaying a key in a selectable state, wherein the key is displayed when the function to be added is added; and downloading and installing the software for adding the function corresponding to the key to add the function when the key is selected.

In addition, the method may further include: comparing mount information regarding a function mounted on the image forming apparatus and the function which can be added with the function information; and acquiring key information regarding the key corresponding to the function which can be added when the function which can be added exists in the function information but it does not exist in the mount information. In this case, in the course of the displaying step, the key can be displayed in a selectable state based on the key information.

Furthermore, the function which can be added may have an attribute regarding function addition. In addition, the attribute regarding the function addition may be a kind or a level of importance of the function.

Thus, in the course of the acquiring step, the following operation a) or b) is performed depending on the attribute of the function,

a) adding the function by downloading and installing the software for adding the function corresponding to the function, and acquiring key information of a key displayed when the function is added, or

b) acquiring key information of a key displayed when the function is added.

In addition, it may further include uninstalling software corresponding to the function and deleting the function when the added function meets a predetermined deletion requirement.

In addition, the deletion requirement can select any one of a case where a period in which the function is not used exceeds a predetermined period, a case where a memory of the image forming apparatus runs out, or a case where usage of the function is completed.

Still furthermore, the software can be downloaded from at least one of a server, a terminal device or another image forming apparatus connected to the image forming apparatus through a network.

It is preferable that the key is displayed in the same position and the same design as the case where the software for adding the function is installed and the function is added.

Furthermore, the function adding method of the image forming apparatus may be constituted as a function addition program of the image forming apparatus executed by a computer. In addition, the function addition program of the image forming apparatus may be stored in a recording medium which can be read by the computer.

According to the image forming apparatus and the function adding method of the image forming apparatus in the present invention, when there is a function which can be added, since only a key is displayed on the operation panel in a selectable state without adding the function itself, it can be selected by the same operation as that of the added function. It is noted that the key is displayed when the function is added. Thus, even when the user selects the key which is displayed on the operation panel but whose corresponding function is not added, since the function can be automatically added, the operability of function addition and function selection can be improved and the user can use the newly added function unconsciously.

In addition, according to another example of the image forming apparatus and function adding method of the image forming apparatus in the present invention, when the added function meets the predetermined deletion requirement, the software corresponding to the function to be uninstalled is automatically uninstalled and the function is deleted. Thus, the memory can be prevented from being wasted because the unnecessary function is deleted.

### BRIEF DESCRIPTION OF THE DRAWINGS

The present invention will become readily understood from the following description of preferred embodiments thereof made with reference to the accompanying drawings, in which like parts are designated by like reference numeral and in which:

FIG. 1 is a schematic view showing a constitution of a system including an image forming apparatus according to an embodiment 1 of the present invention;

FIG. 2 is a block diagram showing a physical constitution of the image forming apparatus according to the embodiment 1 of the present invention;

FIG. 3 is a schematic view showing a concrete constitution example of a scanner and a printer of the image forming apparatus according to the embodiment 1 of the present invention;

FIG. 4 is a block diagram showing a functional constitution of the image forming apparatus according to the embodiment 1 of the present invention;

FIG. 5 is a flowchart showing a method of adding a function to the image forming apparatus according to the embodiment 1 of the present invention;

FIG. 6 is a flowchart showing a detail of step S02 for confirming information of a function to be added in FIG. 5;

FIG. 7 is a flowchart showing a detail of step S03 for confirming an input in FIG. 5;

FIG. 8 is a flowchart showing a detail of step S04 for adding the function in FIG. 5;

FIG. 9 is a flowchart showing a detail of step S06 for auto-deleting the function in FIG. 5;

FIG. 10 is a fundamental display screen example of an operation panel of the image forming apparatus according to the embodiment 1 of the present invention when a power is turned on;

FIG. 11 is a display example of a document setting screen displayed when a document tab is touched in FIG. 10;

FIG. 12 is a display example of a setting screen of a document binding margin displayed when the document binding margin is touched in FIG. 11;

FIG. 13 is a display example of a setting screen of the document binding margin to which a right binding function is added in FIG. 12;

FIG. 14 is a display example of a document setting screen in which it can be confirmed that the right binding function is selected in FIG. 13;

FIG. 15 is a display example of an application setting screen displayed when an application tab is touched in FIG. 10;

FIG. 16 is a display example of an application setting screen in which a function is added to the application setting screen in FIG. 15;

FIG. 17 is a display example of a stamp setting screen when a stamp function is selected in FIG. 16; and

FIG. 18 is a display example of an application setting screen in which it can be confirmed that the stamp function is set in FIG. 17.

### DESCRIPTION OF THE PREFERRED EMBODIMENTS

An image forming apparatus and a function adding method of the image forming apparatus according to an embodiment of the present invention will be described with reference to the accompanying drawings. In addition, substantially the same members in the drawing are allotted to the same reference numerals.

### Embodiment 1

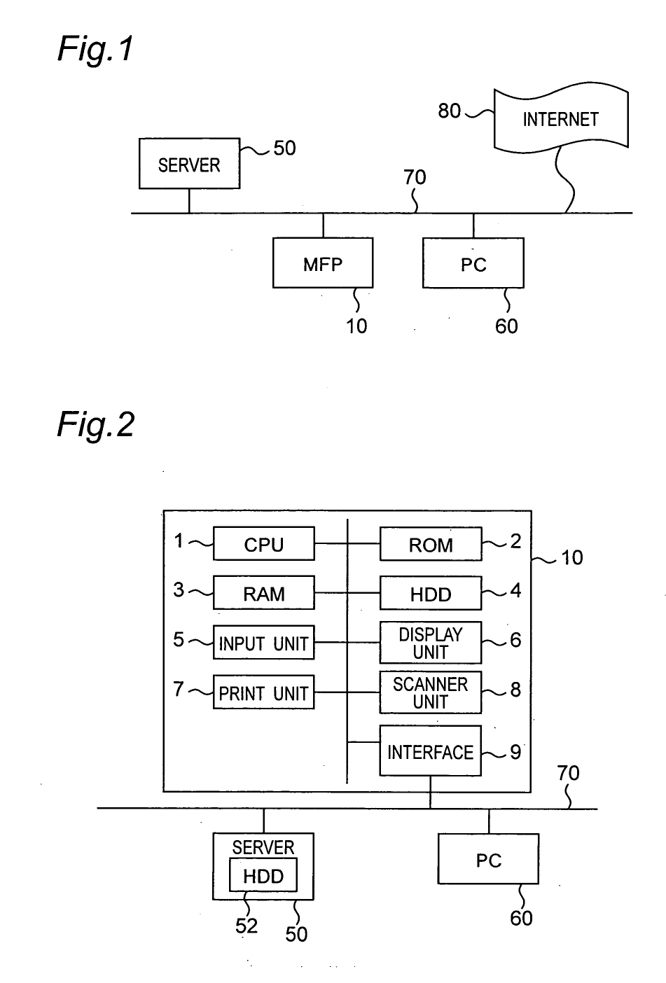

FIG. 1 is a schematic view showing a constitution of a network system comprising an image forming apparatus (MFP) 10 according to an embodiment 1. In this network system, the image forming apparatus (complex apparatus) 10, a server 50 and a PC terminal 60 are connected to a network 70. The network 70 may be connected to an external network such as the Internet 80.

The server 50 has a function to download information in an official website of a manufacturer of the image forming apparatus 10 via the Internet 80, for example, and when software for adding a function which provides a function which can be added to the image forming apparatus 10 and its related information are available in the website, the software for adding the function and information regarding the software can be downloaded and stored in the server 50.

The image forming apparatus 10 can refer to information regarding the software for adding the function stored in the server 50 and confirm whether the function which can be added to the image forming apparatus 10 is stored in the server or not. The image forming apparatus 10 can download and install the software for adding the function from the server 50 according to need to add the function. A method of adding the function will be described later. In addition, a function which is not used often can be deleted by uninstalling its software.

The PC terminal 60 transmits print data to the image forming apparatus 10 through the network 70 and acquires a desired print output from the image forming apparatus 10, so that the image forming apparatus 10 can be used as a printer. In addition, a document is read by the image forming apparatus 10, and the read image data is transmitted from the image forming apparatus 10 to the PC terminal 60 through the network 70, and the image data can be received by the PC terminal 60.

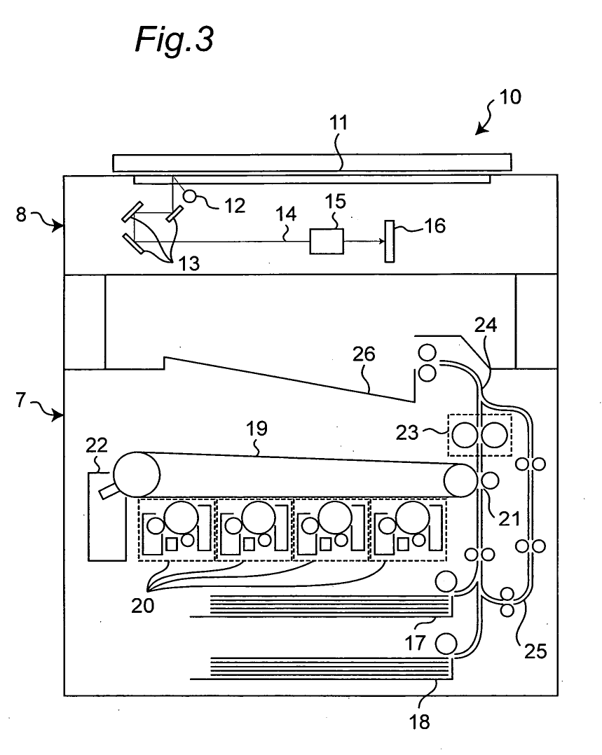

FIG. 2 is a block diagram showing a physical constitution of the image forming apparatus 10. The image forming apparatus 10 comprises a CPU 1, a ROM 2, a RAM 3, a HDD 4, an input unit 5, a display 6, a printer 7, a scanner 8, and an interface 9 which can be connected to the network 70. FIG. 3 is a schematic view showing a concrete constitution of the scanner 8 and the printer 7 of the image forming apparatus 10. The scanner 8 comprises a document table 11 on which a document is set, an exposure lamp 12 for irradiating the document with light, moving on a lower face of the document table, an optical system comprising a reflection mirror 13 and a lens 15 to form an image by the reflection light 14 from the document, a CCD 16 for converting the formed document image to an electrical signal, and a reading controller (not shown) for controlling an operation of each unit. The image data which was converted to the electrical signal by the CCD in the scanner 8 is processed variously and stored in an image memory (not shown). The printer 7 is a color printer having a so-called tandem construction and comprises two sheet feeding units 17 and 18, a sheet discharging unit 26, a both-side conveying unit 25 in which both-side printing is performed and a printing controller (not shown) for controlling an operation of each unit. In addition, four imaging units 20 form images of four colors such as yellow, magenta, cyan, and black, respectively. Each unit comprises a photoconductor, a charge roller, a LED print head, a developing unit, and a cleaner. In addition, since normally used ones are used for the parts constituting the unit, their detailed description will be omitted.

Next, procedures for printing the image will be described.

(a) The image data stored in the image memory is sequentially read out color by color and developed by each imaging unit 20.

(b) The formed image is sequentially transferred to a transfer belt 19 on which four colors overlap with each other, so that a full-color image is formed on the transfer belt 19.

(c) A sheet is fed from the first or the second sheet feeding unit 17 or 18 and the sheet is conveyed along a conveyance path and the full-color image on the transfer belt 19 is transferred to the sheet.

(d) Then, after the image is fixed onto the sheet by a fixing unit 23 and the sheet is discharged from the sheet discharging unit 26. Thus, the image is printed by the above procedures.

In addition, in a case of both-side printing, after the image is printed on one surface of the sheet, the sheet is discharged halfway from the sheet discharging unit 26 and after a rear end of the sheet passes through a conveyance path changing unit 24, a sheet discharging roll of the sheet discharging unit 26 is reversely rotated and the sheet is sent to the both-side conveyance path 25. When the conveyance path changing unit 24 conveys the sheet in a reverse direction, the sheet is sent to the both-side conveyance path 25. While the sheet passes through the both-side conveyance path 25, the imaging unit 20 forms an image to be printed on a back surface of the sheet and a transferring unit 21 transfers the image on the back surface of the sheet, the fixing unit 23 fixes it and the sheet discharging unit 26 discharges the sheet. Thus, the both-side printing is completed.

In addition, since a normally used one is used for each member regarding the both-side printing also, its detailed description will be omitted.

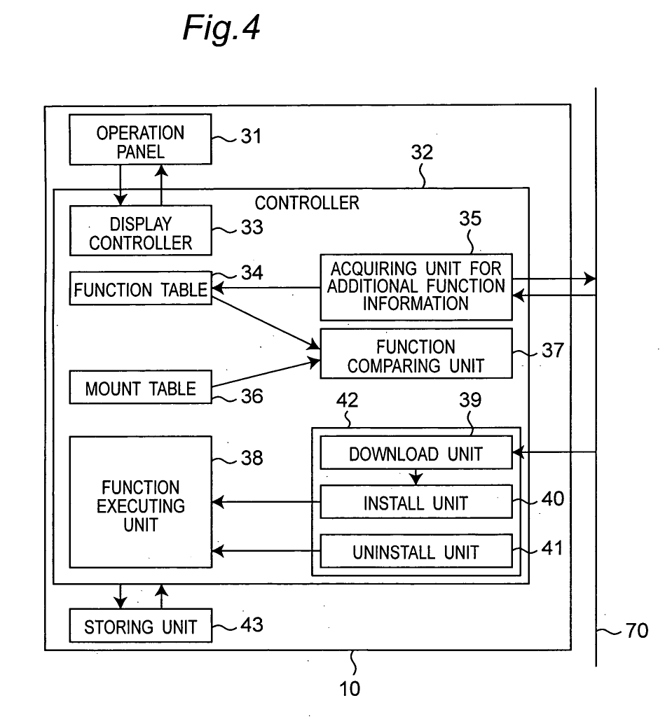

FIG. 4 is a block diagram showing a functional constitution of the image forming apparatus 10. The image forming apparatus 10 comprises an operation panel 31 which displays data and receives an input operation from a user, a controller 32, and a memory unit 43 which stores image data, setting and the like. In addition, the controller 32 comprises a display controller 33 which controls the operation panel 31, an additional function information acquiring unit 35 which acquires a function table in which function information regarding the function which can be added to the image forming apparatus 10 is listed, a function comparing unit 37 which compares the acquired function table 34 with a mount table 36 in which mount information regarding a function mounted on the image forming apparatus 10 is listed, a function executing unit 38 which executes an added function, and a function managing unit 42 which manages addition and deletion of the function. The function managing unit 42 includes a download unit 39 which downloads the software, an install unit 40 which installs the downloaded software to add the non-mounted function, and an uninstall unit 41 which uninstalls the installed software to delete the added function. The additional function information acquiring unit 35 and the function managing unit 42 acquire the information or download the software via the network 70.

Next, an operation of each component to add the function to the image forming apparatus 10 will be described.

The image forming apparatus 10 acquires the function table 34 by the additional function information acquiring unit 35 from the server 50, compares the function table 34 with the mount table 36 which is a list of the function mounted in the image forming apparatus 10 by the function comparing unit 37 to determine whether the function which can be added is contained or not. When the function which can be newly added is contained, a key which is displayed when the function is added is displayed in a selectable state on the operation panel 31 by the display controller 33. In this case, the software for adding the function is not installed yet and the function itself is not added. Then, when an input from the operation panel 31 and the like is confirmed, it is determined whether there is a non-mounted function in the function selected by the input or not. When the non-mounted function exists, the software for adding the function which corresponds to that function is downloaded by the download unit 39 and then the function is added by the install unit 40. Then, the selected function is performed by the function executing unit 38. Thus, operability of the function addition can be improved and the user can use the added function unconsciously. In addition, when the added function meets a predetermined deletion requirement, the function is deleted by the uninstall unit 41. Thus, since an unnecessary function can be deleted, a memory is prevented from being consumed in vain. In addition, when the key of the deleted function is displayed as it is even after the deletion, it is not necessary to newly add the key.

A table 1 is an example of the function table 34 in which function information regarding the function which can be added and stored in the server 50 is listed.

TABLE 1

| Function | Key | Level of | | | |
|---|---|---|---|---|---|
| name | name | importance | Key added position | File name | Version |
| Document | Right | Middle | Document/document right | Oring_Margin_R | 2.10 |
| right | | | binding margin/180.80 | | |
| binding | | | | | |
| margin | | | | | |
| Booklet | Booklet | Low | Application/+ | App_Booklet | 2.00 |
| Stamp | Stamp | Middle | Application/+ | App_Stamp | 1.20 |
| Stamp | *** | Middle | Application/stamp/150.50 | App_Stamp_Date | 1.20 |
| date | | | | | |
| Stamp | *** | Middle | Application/stamp/150.80 | App_Stamp_Time | 1.20 |
| time | | | | | |
| Stamp | *** | Middle | Application/stamp/150.110 | App_Stamp_Page | 1.20 |
| page | | | | | |
| Finish | — | High | Standard/finish | Basic_Finish_Exp | 2.00 |
| extension | | | | | |

The function table 34 is stored in a certain place of the server 50, in a hard disk 52 in FIG. 2, for example as a file, and it contains information regarding a function name, a key name (displayed in the operation panel 31), a level of importance (This shows an importance level. When the level is high, the function is immediately added without waiting for the function selection by the user), an added position of the key (a tag when displayed in the operation panel, a position coordinate in the tag and the like), a file name (a file name of software which is needed to add the additional function to be added), a version of the software and the like.

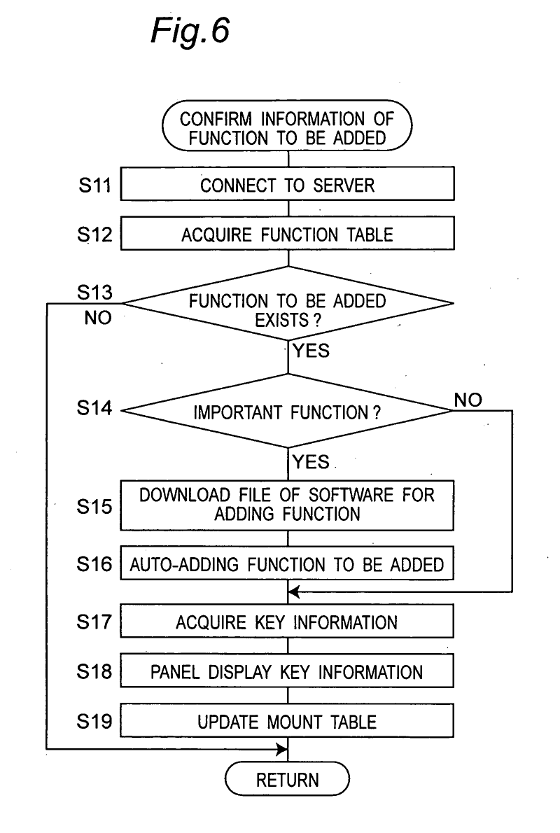

Meanwhile, the image forming apparatus 10 has the mount table 36 in which mounted information regarding the already mounted function is listed. A table 2 is an example of the mount table 36. In this mount table 36, whether a key regarding the function is added to the operation panel 31 or not is managed using a key addition flag. In addition, whether the function has been added or not is managed using an addition flag with each function, for example. In addition, whether the function is added by auto-adding shown in FIG. 6 or not is managed using an auto-adding flag with each function, for example.

TABLE 2

| Function | Document right | | Finish |
|---|---|---|---|
| name | binding margin | Booklet | extension |
| Key name | Right | Bookle | — |
| Level of | Middle | Middle | High |
| importance | | | |
| Key added | Document/document | Application/+ | Standard/ |
| position | right binding | | finish |
| | margin/180.80 | | |
| File name | Oring_Margin_R | App_Booklet | Basic_Finish_Exp |
| Version | 2.10 | 2.00 | 2.00 |
| Key addition | 1 | 1 | 1 |
| flag | | | |
| Addition flag | 0 | 0 | 1 |
| Auto-adding | 0 | 0 | 1 |
| flag | | | |

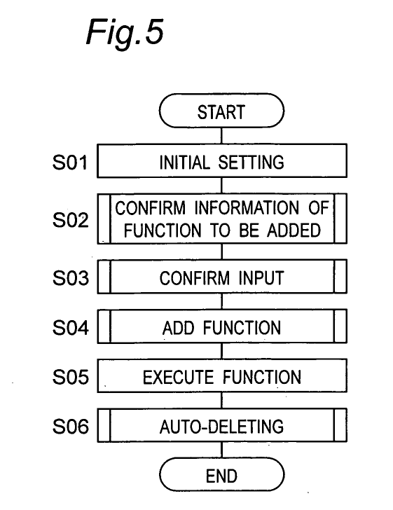

FIG. 5 is a flowchart showing the method of adding the function of the image forming apparatus.

(a) When the image forming apparatus 10 is started, necessary initial settings are performed at S01. The initial settings comprises a setting of a CPU or a register memory of a peripheral device, a setting of an initial state of an output port, a confirmation of a state of an input port, a display of an initial screen of the operation unit, an initialization of various kinds of interfaces and the like.

(b) After the initial settings are completed, a subroutine in which the function to be added and stored in the server 50 is confirmed is called at S02. This subroutine for confirming the information of the function to be added will be described later.

(c) Then, it is confirmed whether there is an input from the operation panel 31 or not at S03. This input confirmation will be described later.

(d) It is confirmed whether the function selected by the above input is mounted in the image forming apparatus 10 or not and when there is a non-mounted function, a subroutine for adding the function is called at S04. This subroutine for the function addition will be described later.

(e) After the function is added, an operation of the function whose operation is set is executed at S05.

(f) Then, the subroutine for deleting is called and the function which is determined to be unnecessary is automatically deleted at S06. This subroutine for the auto-deleting will be described later.

Thus, the function addition is controlled by the above operations.

FIG. 6 is a flowchart showing a detail of the step S02 in FIG. 5 in which the information of the function to be added is confirmed.

(a) First, the image forming apparatus 10 is connected to the server 50 in which the software for adding the function and the function table 34 regarding the software shown in the table 1 are stored through the network 70 at S11, and acquires the function table shown in the table 1 at S12.

(b) Then, the acquired first function table 34 is compared with the mount table 36 of the table 2 regarding the function mounted in the image forming apparatus 10 and it is determined whether the function which can be newly added is stored in the server 50 or not at S13. When there is no function to be newly added, the subroutine is completed to return.

(c) When the function which can be added exists, it is determined whether an important function or an indispensable function is contained therein or not at S14. In this case, when an attribute regarding the function addition is specified in each function, as this attribute, for example, a level of importance may be defined as “middle” (or “normal”) and “high” (or “important” or “indispensable”). When the important or the indispensable function exits, the operation is moved to step S15 and when there is no important function nor indispensable function, the operation is moved to step S17 without installing the software for adding the function.

(d) When the important or indispensable function exists, the file of the software needed to add the function is downloaded at S15 and automatically installed to add the function at S16.

(e) Then, key information regarding a key displayed on the operation panel when the function is added is acquired at S 17. This key information may be contained in the function table 34 or contained in the software. When the key information is contained in the function table 34, the key information is acquired from the function table 34. Alternatively, when the key information is contained in the software, only the key information is acquired from the software.

(f) Based on the acquired key information, the key for selecting the function is added to the operation panel 31 so as to be able to be selected at S18. In addition, the key is displayed in the same position and the same design as the case where the software for adding the function is installed to add the function.

(g) Then, the mount table shown in the table 2 is updated so that the function is added and the like at S19. When the function is important or indispensable, since the software for adding the function is immediately installed, a flag showing the key addition is set at “1” and a flag showing the addition is set at “1” and a flag showing auto-adding is set at “1”. Meanwhile, when the function is not important and not indispensable, the flag showing key addition is set at “1” and the flag showing not-added is set at “0”.

Thus, the subroutine for confirming the information of the function to be added is completed to return.

Since the level of the importance is determined, the indispensable function can be automatically added without hindering the operation of the image forming apparatus and the function other than that is not added, so that the memory is prevented from being wasted.

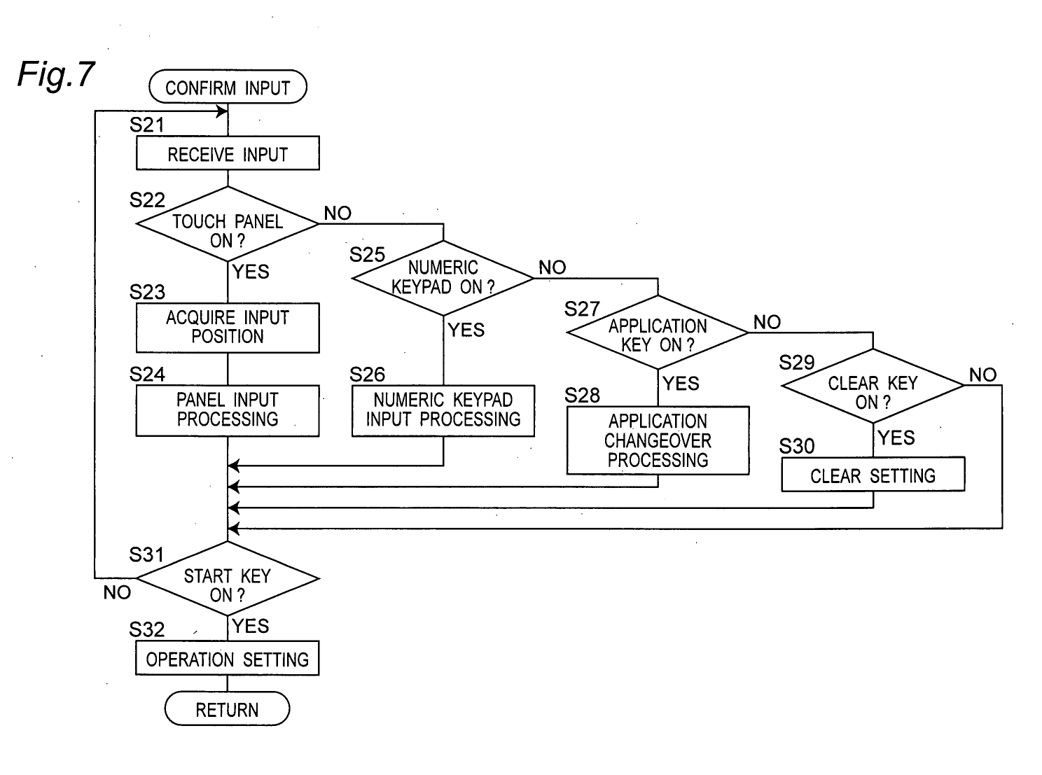

FIG. 7 is a flowchart showing a detail of the step S03 in FIG. 5 in which the input is confirmed.

(a) The input from the user is received at S21. That is, the input includes an input of a touch panel of the display, an input of a numeric keypad, an input of a start key, and an input of an application key.

(b) It is determined whether the input is the input of the touch panel or not at S22. When it is the input of the touch panel, touched position information is acquired at S23. When the key is displayed at the touched position, an operation corresponding to the key, for example, a display switchover or a change of operation setting is performed at S24.

(c) It is determined whether the input is the input of the numeric keypad or not at S25. When it is the input of the numeric keypad, an input operation corresponding to the pressed numeric value, for example, setting of the number of copies or setting of a telephone number is performed at S26.

(d) It is determined whether the input is the input of the application key or not at S27. When it is the input of the application key, control is changed to the application (copying, scanning, faxing) corresponding to the pressed key and the display is changed at S28.

(e) It is determined whether the input is the input of the clear key or not at S29. When it is the input of the clear key, the set contents so far are cleared at S30.

(f) It is determined whether the input is the input of the start key or not at S31. When it is the input of the start key, the operation is returned to input reception at S21. When it is not the input of the start key, an operation corresponding to the set contents is set at S32. Thus, the subroutine for confirming the input is completed to return.

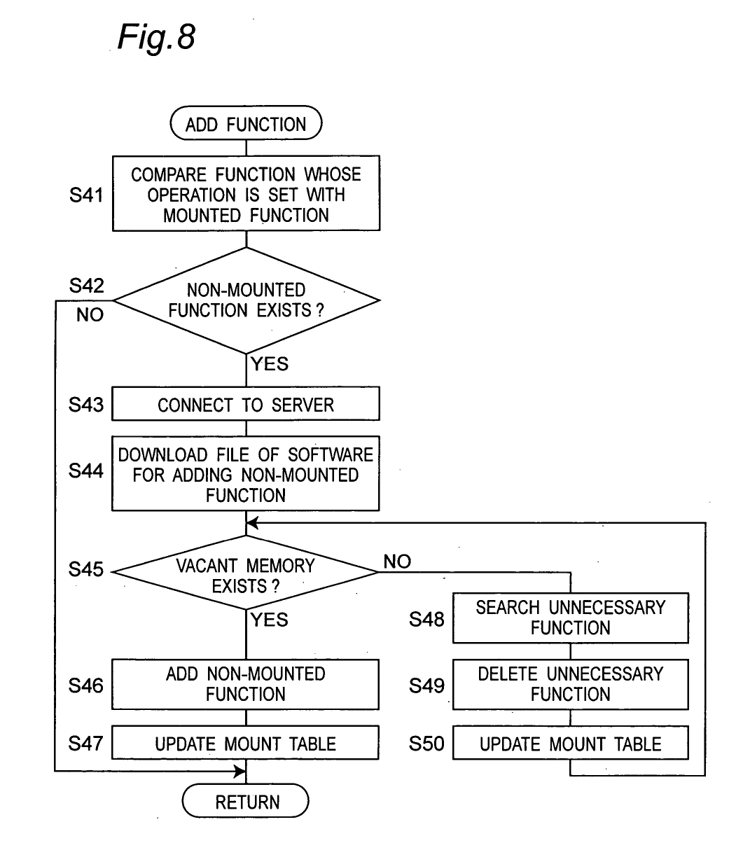

FIG. 8 is a flowchart showing a detail of the step S04 for the function addition in FIG. 5.

(a) The function whose operation is set is compared with the mounted function at S41. More specifically, each function whose operation is set is compared with the function listed in the mount table shown in the table 2 so as to relate them.

(b) It is determined whether there is a non-mounted function or not at S42. That is, it is determined whether the addition flag of each function in the mount table in the table 2 is “1”, that is, the function is already added or it is “0”, that is, the function is not added. When the function is already added, since the function is already added, another function is determined whether it is mounted or not. After all functions are determined whether they are mounted or not, when there is no function which is not mounted, the subroutine for adding the function is completed to return.

(c) When it is confirmed that there is an un-mounted function at step S42, the image forming apparatus 10 is connected to the server 50 through the network 70 at S43.

(d) The image forming apparatus 10 downloads the file of the software for adding the non-mounted function from the server 50 at S44.

(e) It is determined whether there is a vacant memory or not at S45. When the vacant memory exists, the operation is moved to step S46 and when it is not, the operation is moved to step S48.

(f) When the vacant memory exists, the software is installed and the non-mounted function is added at S46.

(g) Then, the mount table 36 is updated at S47. More specifically, the addition flag of the function added to the mount table in the table 2 is changed from “0” to “1”.

(h) When there is no space in the memory at step S45, in order to provide the vacant memory, an unnecessary function which meets the predetermined deletion requirement is retrieved in the function which has been already added at S48. The predetermined deletion requirement is a case where the level of importance is “low”, or a case where the level is “middle” and the function is not used for the longest time, for example.

(i) The unnecessary function is deleted at S49. In addition, the display of the key corresponding to the deleted function is maintained in a state which can be selected as it is.

(j) The mount table 36 is updated at S50. More specifically, the addition flag of the deleted function from the mount table of the table 2 is changed from “1” to “0”. Then, the operation is returned to S45 for confirming the vacant memory.

Thus, the subroutine is completed to return.

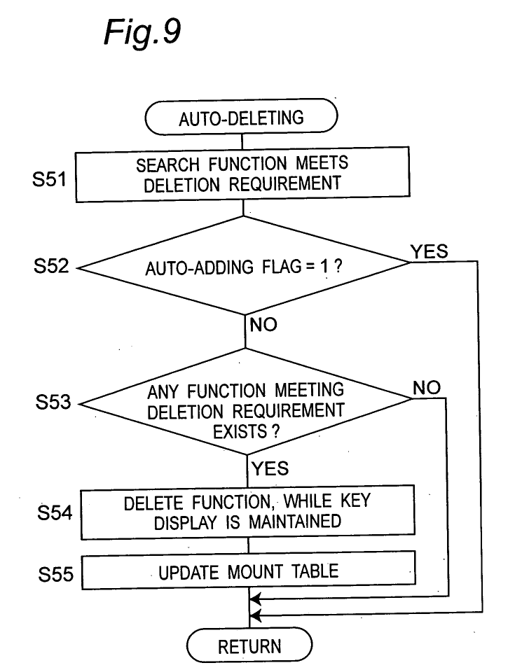

FIG. 9 is a flowchart showing a detail of step S06 of the auto-deleting in FIG. 5.

(a) An added function to be deleted is retrieved at S51.

(b) It is determined whether auto-adding flag of each function is “1” or not and when it is “1”, the function is not to be deleted at S52.

(c) It is determined whether each function meets the predetermined set deletion requirement or not at S53. This deletion requirement is a case where the function is not used for a predetermined period of time, for example. A usage history of each function may be recorded to confirm this deletion requirement. For example, a column for recording a last used date may be provided in the mount table of the table 2. As another deletion requirement, there is a case where a vacant memory of a program region becomes less than a predetermined capacity. According to this deletion requirement, when the vacant capacity of the memory is related to the function and previously set in each function, the functions to be deleted are prioritized such that a certain function is deleted when the vacant capacity of the memory becomes a certain value, and a certain function is deleted when the vacant capacity is further decreased to be a certain value, and so on. In addition, as another deletion requirement, regarding the function which is considered to be used rarely, the deletion requirement can be set for this function such that after it is used, it is to be deleted. In this case, the function is only added when it is used.

(d) The function is deleted by uninstalling the software regarding the function to be deleted at S54. In addition, the key corresponding to the deleted function is still displayed as it is.

(e) The mount table 36 is updated at S55. More specifically, the addition flag of the deleted function is changed from “1” to “0” in the mount table of the table 2.

Thus, the subroutine for deleting the unnecessary function is completed to return.

Because the step S06 is provided, the function other than the function whose level of importance is “high” is automatically deleted under the predetermined deletion requirement so that the memory can be prevented from being used in vain.

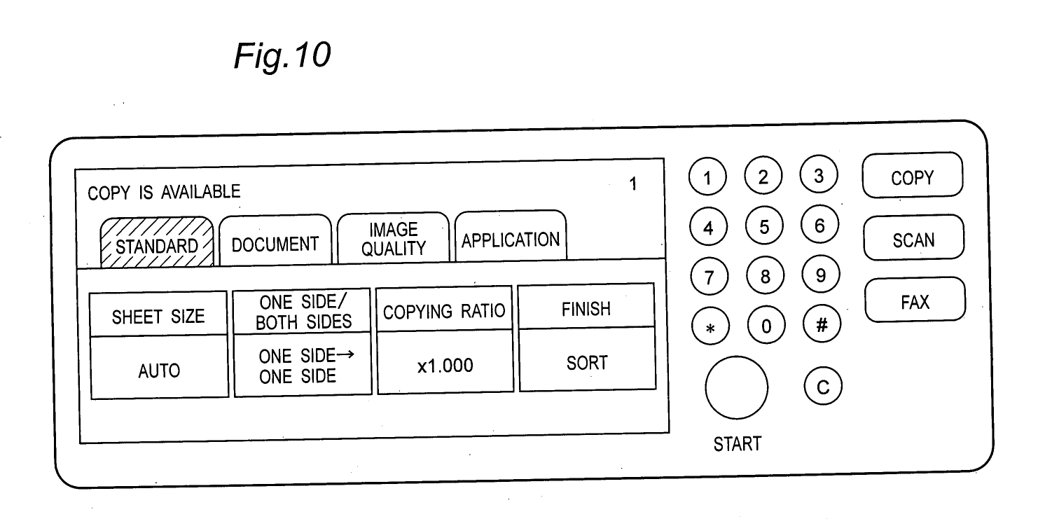

Hereinafter, an example of the function addition of the image forming apparatus will be described with reference to FIGS. 10 to 18 which show concrete display examples of the operation panel 31 of the image forming apparatus.

FIG. 10 is a display screen example of the operation panel 31 of the image forming apparatus 10. This display screen example is a display example of a fundamental screen in a copy mode and this is displayed first after a power is turned on. The operation panel 31 comprises a display and operation keys. A touch panel is mounted on the display and a key is displayed in a state it can be selected and a corresponding key can be inputted. Meanwhile, the operation keys comprise application keys for changing over each operation mode of copying, scanning, and faxing, a numeric keypad for input numeric such as the number of copies, a telephone number or the like, a clear key to correct an error input, and a start key to instruct an operation start.

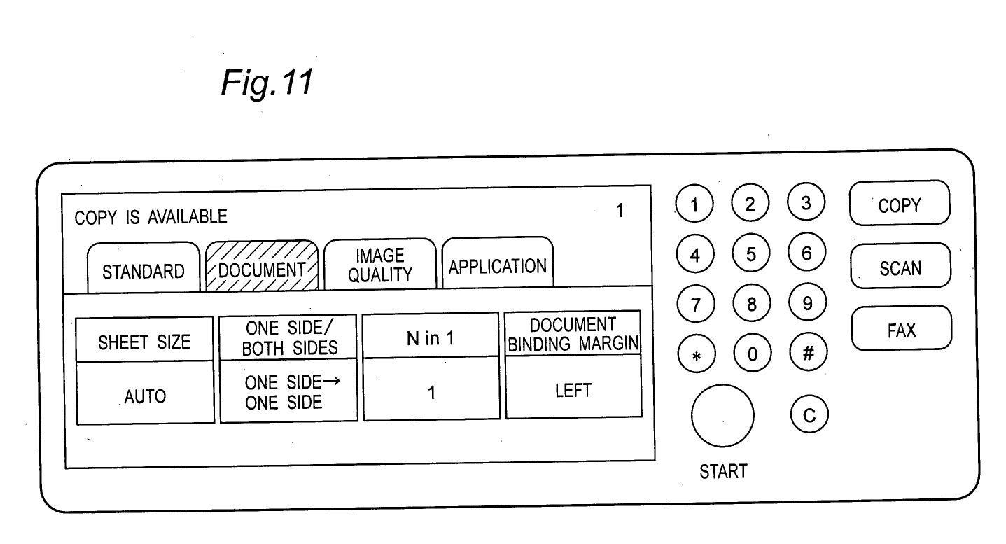

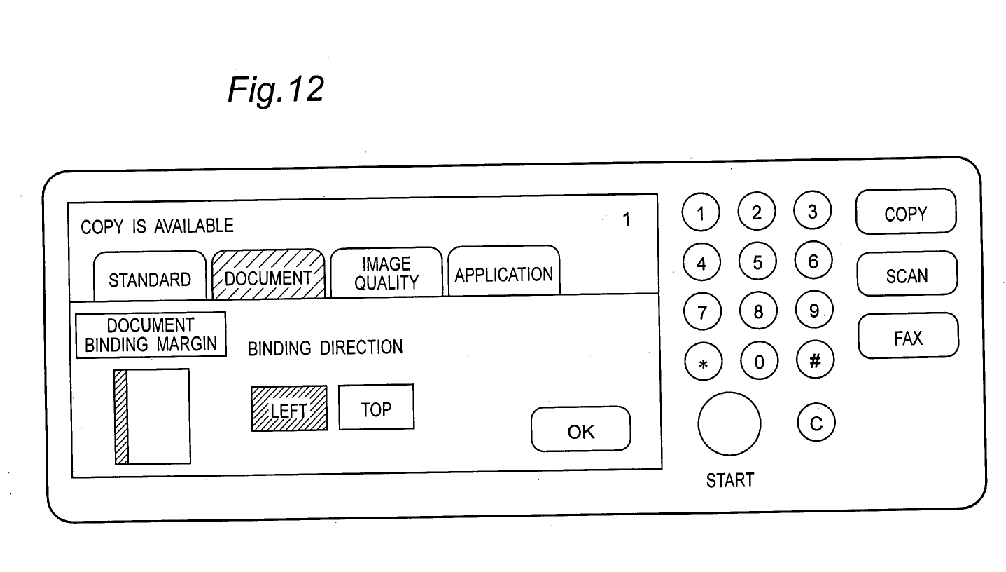

Fundamental setting can be performed from this screen. In order to perform another kind of setting from this fundamental screen, any tab of “document”, “image quality” or “application” is touched to change over the display. When the tab of “document” is touched, the display is changed to a document setting screen (FIG. 11). In this screen, an operation regarding the document can be set. For example, a key display of “document binding margin” is touched, the screen is changed to a setting screen of the document binding margin (FIG. 12). As can be shown in this setting screen, functions to set the direction of the document binding margin at “left” and “top” are mounted.

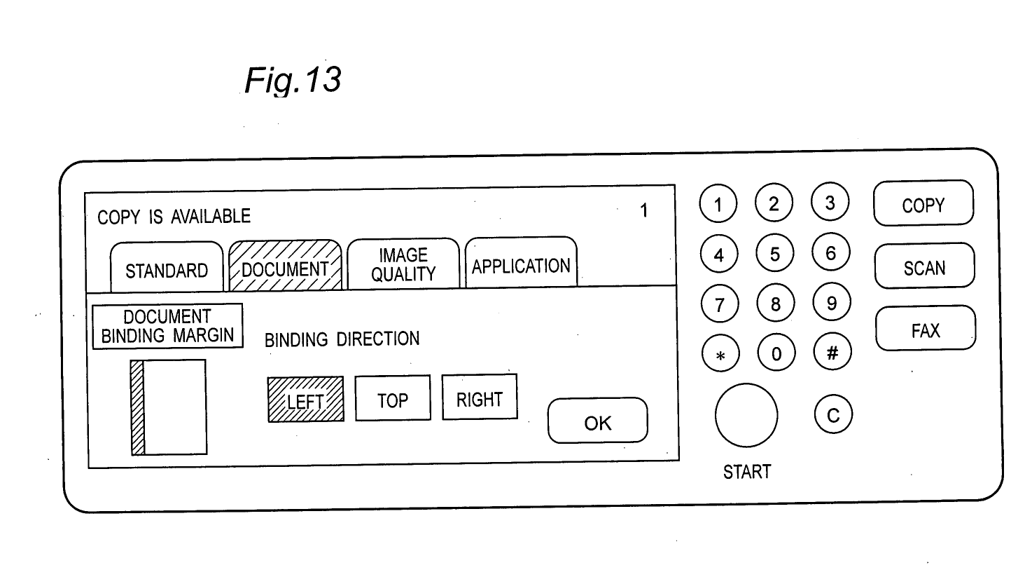

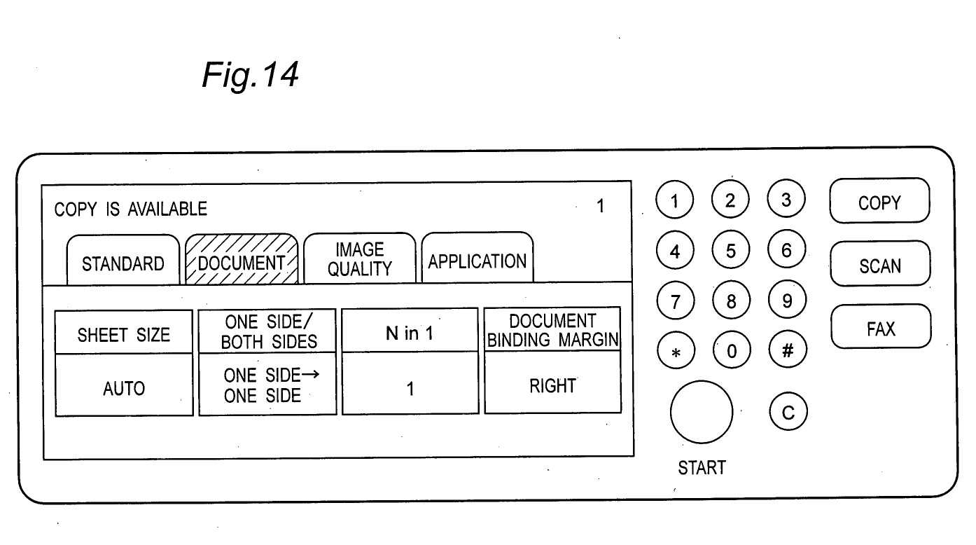

Next, as a concrete example of the function addition, in a case where a function of “right-side binding of document” is added to the “document binding margin”, a change of the panel display will be described with reference to FIGS. 13 and 14.

1) The function table 34 of the table 1 acquired from the server 50 is compared with the mount table of the table 2 which is a list of the mounted function in the image forming apparatus 10 and when the function of “right-side binding of document” exists in the function table 34 but it is not contained in the mount table 36, it is determined that the function of “right-side binding of document” can be added.

2) Key information such as a key title, an added position of a key and the like regarding the function of “right-side binding” is acquired and a key for selecting the function of “right-side binding” is displayed on the operation panel so that it can be selected (FIG. 13). However, in this stage, software to implement the function of “right-side binding” is not added yet and only the key is displayed.

3) When the user press the key of this “right-side binding” on the operation panel to select the “right-side binding” and press “OK”, the screen returns to the document setting screen and it can be confirmed that the “right” is set in the document binding margin (FIG. 14).

4) Then, the start key is pressed to confirm the setting contents and when the operation is started, it is detected that the function of “right-side binding” is not mounted in the set functions, and the software for adding the function is downloaded from the server 50 and installed, so that the function of “right-side binding” is added. Then, the set function is executed.

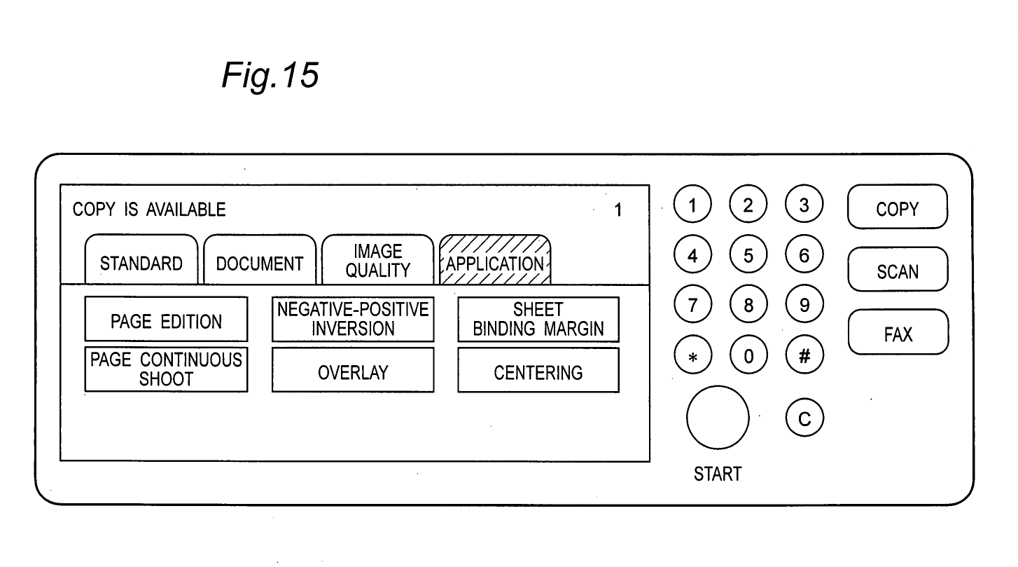

In addition, FIG. 15 is an application setting screen which is displayed when the “application” tab is selected in the screen example in FIG. 10. In this image forming apparatus 10, as functions of applications, “page edition”, “negative-positive inversion”, “sheet binding margin”, “page continuous shoot”, “overlay”, and “centering” are mounted.

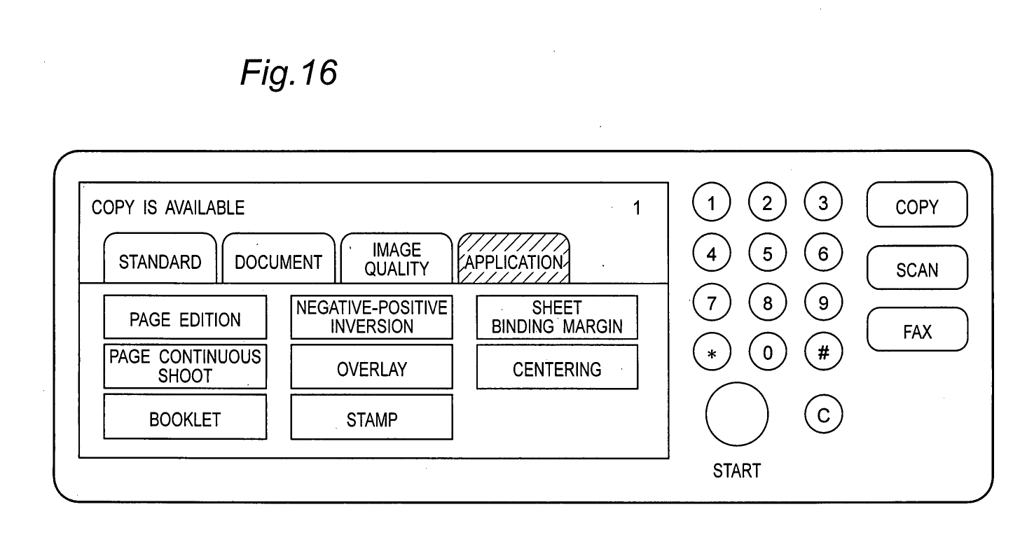

In addition, as a concrete example of another function addition, a case where functions of “booklet” and “stamp” are added to the “application” will be described with reference to FIGS. 16 to 18.

1) The function table 34 of the table 1 acquired from the server 50 is compared with the mount table of the table 2 of the list of the functions mounted in the image forming apparatus 10 by the function comparing unit 37 and when the “booklet” and “stamp” exist in the function table 34, but they are not contained in the mount table 36, it can be determined that the functions of the “booklet” and the “stamp” can be added.

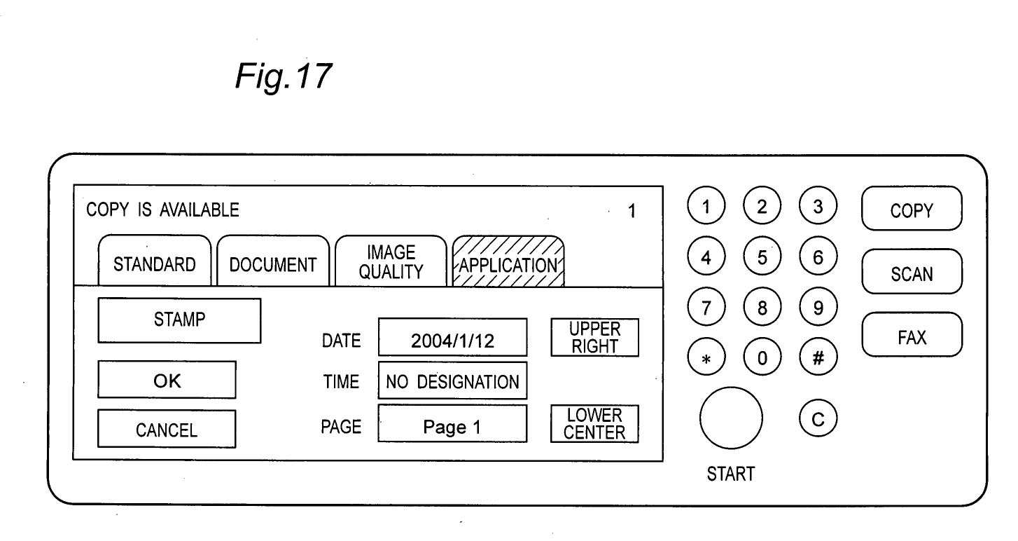

2) Key information such as a key title, an added position of a key and the like regarding the “booklet” and “stamp” is acquired and keys for selecting the “booklet” and “stamp” are displayed on the operation panel so that they can be selected (FIG. 16). However, in this stage, software to implement the “booklet” or “stamp” is not installed yet and only the keys are displayed. Since it is necessary to specify a kind of the stamp and its position in the function of the “stamp”, a screen (FIG. 17) displayed when the “stamp” is pressed and key displays for “date”, “time”, and “page” are added at the same time. The relation of those low-level functions is managed in the table 1 (not shown).

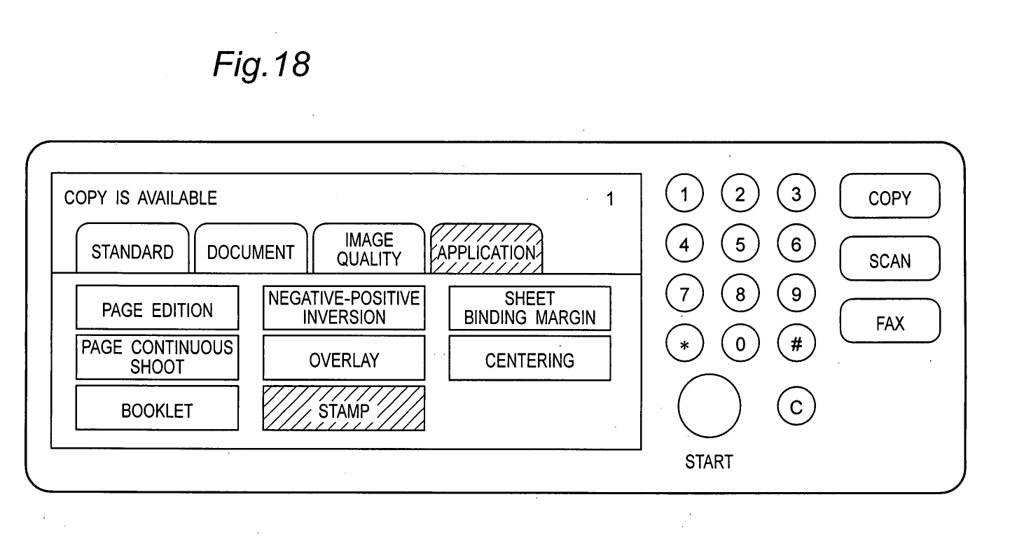

3) When the user presses the key of this “stamp” on the operation panel and selects various settings and presses “OK”, the screen returns to the application setting screen (FIG. 18). In this case also, since the key of the “stamp” is highlighted so that it can be confirmed that the stamp function is set.

4) Then, the start key is pressed to confirm the setting contents and when the operation is started, it is detected that the “stamp” function is not mounted in the set functions, and the software for adding the function is downloaded from the server 50 and installed, so that the “stamp” function is added. Then, the set function is executed.

In addition, as shown in the table 1, since the “stamp” function has the low-level functions such as “stamp date”, “stamp time, “stamp page” and the like, only the function selected among the “stamp date”, “stamp time, and “stamp page” may be added depending on the selected key without adding an entire stamp function. In addition, the software may be installed at the time of selecting the function.

The image forming apparatus according to the present invention can be applied to the image forming apparatus in which the function can be added by downloading the software for adding the function.

Although the present invention has been described in connection with the preferred embodiments thereof with reference to the accompanying drawings, it is to be noted that various changes and modifications are apparent to those skilled in the art. Such changes and modifications are to be understood as included within the scope of the present invention as defined by the appended claims, unless they depart therefrom.

What is claimed is:

1. An image forming apparatus to which a function can be added by downloading and installing software for adding the function, comprising:
an information acquiring unit which acquires function information regarding the function which can be added to the image forming apparatus;
an operation panel which displays a key in a selectable state, wherein the key is displayed when the function is added; and
a function managing unit which downloads and installs the software for adding the function corresponding to the key to add the function when the key is selected.

2. The image forming apparatus according to claim 1, wherein the software is downloaded and installed and then the function is executed based on an executing instruction of the added function.

3. The image forming apparatus according to claim 1, further comprising a function comparing unit which compares mount information regarding a function mounted on the image forming apparatus with the function information, wherein
the function managing unit acquires key information regarding the key corresponding to the function which can be added when the function which can be added exists in the function information but it does not exist in the mount information, and
the operation panel displays the key in a selectable state based on the key information.

4. The image forming apparatus according to claim 3, wherein the function which can be added has an attribute regarding function addition, and
the function managing unit performs the following operation a) or b) depending on the attribute of the function,
a) adding the function by downloading and installing the software for adding the function corresponding to the function, and acquiring key information of a key displayed when the function is added, or
b) acquiring key information of a key displayed when the function is added.

5. The image forming apparatus according to claim 4, wherein the attribute regarding the function addition is a kind or a level of importance of the function.

6. The image forming apparatus according to claim 4, wherein the function managing unit determines whether it uninstalls software corresponding to the function and deletes the function or not, depending on whether auto-adding is performed or not.

7. The image forming apparatus according to claim 6, wherein the function is deleted when the function meets the deletion requirement, and the deletion requirement is a case where a period in which the function is not used exceeds a predetermined period, a case where a memory of the image forming apparatus runs out, or a case where usage of the function is completed.

8. The image forming apparatus according to claim 1, wherein the software is downloaded from at least one of a server, a terminal device or another image forming apparatus connected to the image forming apparatus through a network.

9. The image forming apparatus according to claim 1, wherein the key is displayed in the same position and the same design as the case where the software for adding the function is installed and the function is added.

10. A function adding method of an image forming apparatus to which a function is added by downloading and installing software for adding the function, comprising:
acquiring function information regarding a function which can be added to the image forming apparatus;
displaying a key in a selectable state, wherein the key is displayed when the function is added; and
downloading and installing the software for adding the function corresponding to the key to add the function when the key is selected.

11. The function adding method of the image forming apparatus according to claim 10, further comprising:
comparing mount information regarding a function mounted on the image forming apparatus with the function information; and
acquiring key information regarding the key corresponding to the function which can be added when the function which can be added exists in the function information but it does not exist in the mount information,
wherein, in the course of the displaying step, the key is displayed in a selectable state based on the key information.

12. The function adding method of the image forming apparatus according to claim 11, wherein the function which can be added has an attribute regarding function addition, and
in the course of acquiring step, the following operation a) or b) is performed depending on the attribute of the function,
a) adding the function by downloading and installing the software for adding the function corresponding to the function, and acquiring key information of a key displayed when the function is added, or
b) acquiring key information of a key displayed when the function is added.

13. The function adding method of the image forming apparatus according to claim 11, wherein the attribute regarding the function addition is a kind or a level of importance of the function.

14. The function adding method of the image forming apparatus according to claim 10, further comprising:
uninstalling software corresponding to the function; and
deleting the function when the added function meets a predetermined deletion requirement.

15. The function adding method of the image forming apparatus according to claim 14, wherein the deletion requirement is a case where a period in which the function is not used exceeds a predetermined period, a case where a memory of the image forming apparatus runs out, or a case where usage of the function is completed.

16. The function adding method of the image forming apparatus according to claim 10, wherein the software is downloaded from at least one of a server, a terminal device or another image forming apparatus connected to the image forming apparatus through a network.

17. The function adding method of the image forming apparatus according to claim 10, wherein the key is displayed in the same position and the same design as the case where the software for adding the function is installed and the function is added.

18. A recording medium which can be read by a computer, the medium storing a function addition program for causing a computer to execute each step of a function adding method of the image forming apparatus to which a function can be added by downloading and installing software for adding the function, wherein the image-forming apparatus includes: an information acquiring unit which acquires function information regarding the function which can be added to the image forming apparatus; an operation panel which displays a key in a selectable state, wherein the key is displayed when the function is added; and a function managing unit which downloads and installs the software for adding the function corresponding to the key to add the function when the key is selected, wherein the function adding method comprises:
acquiring function information regarding a function which can be added to the image forming apparatus;
displaying a key which is displayed in a selectable state when the function which can be added is added; and
downloading and installing the software for adding the function corresponding to the key to add the function when the key is selected.
